(19) United States
(12) Patent Application Publication
(10) Pub. No.: US 2026/0129690 A1
(43) Pub. Date: May 7, 2026

(54) SYSTEM AND METHOD FOR PROVIDING QUALITY-OF-SERVICE FLOW CONTINUITY

(71) Applicant: Verizon Patent and Licensing Inc., Basking Ridge, NJ (US)

(72) Inventors: Ye Huang, San Ramon, CA (US); Sudhakar Reddy Patil, Flower Mound, TX (US); Ambreen Habib, Golden, CO (US); Lixia Yan, Basking Ridge, NJ (US)

(21) Appl. No.: 18/936,033

(22) Filed: Nov. 4, 2024

(51) Int. Cl. H04W 76/10; H04W 28/02

(52) U.S. Cl. CPC H04W 76/10; H04W 28/0226; H04W 28/0268

(57) ABSTRACT

A device may include a processor. The processor may be configured to: receive, from a core network, a first notification of a path change to a network traffic associated with a User Equipment (UE) device; determine whether the UE is to receive a Quality-of-Service (QoS) flow continuity service by looking up traffic influence information for the UE in a table; and when it is determined that the UE is to receive the QoS flow continuity service, send a message to the core network to provide QoS flow continuity service. The QoS flow continuity service may set a QoS, of a first QoS flow for the UE after the path change, to a QoS of a second QoS flow for the UE prior the path change.

### BACKGROUND INFORMATION

Fifth Generation (5G) networks offer many technological features unavailable in predecessor networks. For example, through use of network slicing, 5G networks may provide application and subscriber-specific Quality-of-Service (QoS) services for a variety of applications. Other benefits of 5G networks include service-based architecture (SBA) application programming interfaces (APIs) for facilitating traffic steering and interfacing with Multiaccess Edge Computing (MEC) clusters. Such mechanisms may provide improved network resource utilization, faster rollout times for new services without significant modifications to the existing network infrastructure, increased security, and decreased latency.

### BRIEF DESCRIPTION OF THE DRAWINGS

FIG. 1 illustrates an overview of a system described herein.

FIG. 2 illustrates an exemplary network environment in which systems and methods described herein may be implemented.

FIG. 3 depicts exemplary Fifth Generation (5G) core network components, according to an implementation.

FIG. 4 is a flow diagram of an exemplary process that is associated with an initial setup for providing Quality-of-Service (QoS) flow continuity.

FIG. 5 shows a diagram illustrating example messages exchanged between different components of a system to set up providing QoS flow continuity.

FIG. 6 is a flow diagram of an exemplary process that is associated with establishing a new QoS flow by a system for providing QoS flow continuity.

FIG. 7 shows a diagram illustrating example messages exchanged between different components of a system for providing QoS flow continuity.

FIG. 8 shows an example traffic influence table, according to an implementation.

FIG. 9 is a flow diagram of an exemplary process that is associated with reestablishing a QoS flow by a system for providing QoS flow continuity.

FIG. 10 shows a diagram illustrating example messages exchanged between different components of a system for providing QoS flow continuity.

FIG. 11 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

Systems and methods described herein relate to Quality-of-Service (QoS) flow in general, and more particularly to providing Quality-of-Service (QoS) flow continuity. Typically it is desirable for networks to provide QoS continuity of services, for instance when the devices are mobile and rehomed to new gateways (e.g., User Plane Functions (UPFs)) to achieve the latency requirements. for example, QoS continuity ensures a smooth and uninterrupted user experience, which is particularly important for real-time applications such as video streaming, Voice-over-Internet Protocol (VoIP), and online gaming, where disruptions can lead to noticeable performance degradation.

In another example, maintaining consistent QoS guarantees that the network can reliably meet the service expectations of users, such as data rates, latency, and error rates. This is critical for business applications and remote work, where performance issues can affect productivity. Many applications, especially those sensitive to delays and packet loss, require a certain level of QoS to function properly. For example, video calls need low latency and steady bandwidth to avoid freezing and lag.

For the Fifth Generation (5G) Standalone (SA) architecture and other advanced network architectures, repositioning of a user device raises significant QoS continuity issues. Specifically, when a User Equipment device (UE) is being relocated or re-anchored to the closest User Plane Function (UPF) in a 5G network (or a Packet Data Network Gateway (PGW) in a 4G network), while in a Service and Session Continuity mode 2 (SSC mode 2) session a with QoS flow (or a QoS (dedicated bearer), the UE receives a new Internet Protocol (IP) address. This repositioning and re-anchoring process present a potential change in the UE's optimal endpoint (e.g., a Multiaccess Edge Computing (MEC) application endpoint). If the UE was set up with a dedicated QoS session on the original UPF, the transition to a new UPF would cause an established Protocol Data Unit (PDU) session to be no longer used. The fundamental reason is the alteration in the network points of attachment and the assignment of the new IP address, essentially decoupling the dedicated QoS flow from the UE—and the existing cellular network does not have mechanism to re-establish a new dedicated QoS flow after the UE re-anchoring. Hence, changes in UE locations and UE re-anchoring can pose challenges to providing uninterrupted QoS to the UEs. The systems and methods described herein resolve these problems.

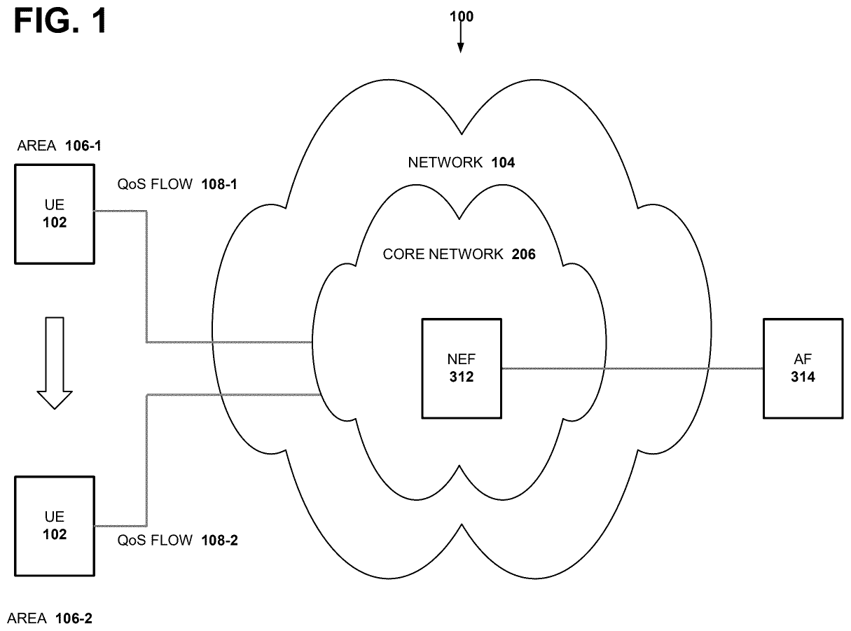

FIG. 1 illustrates an overview of a system described herein. As shown, environment 100 includes a UE 102, a provider network 104 which in turn includes a core network 206, and an application function (AF) 314. When an application on UE 102 establishes a service flow with an application in network 104, the service flow is bundled together with other service flows in a QoS flow (e.g., QoS flow 108-1). Furthermore, QoS flows are then packaged into a PDU session that extends from UE 102 to core network 206. Whereas a PDU session's termination point or an anchor point (e.g., a UPF) is in core network 206, the service flow may extend beyond core network 206, to the application hosted (not shown) on a data network or an external network. Assuming that UE 102 receives services from the application server, the application server may signal network 104 via AF 314 and a Network Exposure Function (NEF) 312 within core network 206.

As further shown, UE 102 may move from an area 106-1 to an area 106-2. When UE 102 moves, the PDU session between UE 102 and a UPF (not shown) in core network 206 may be re-anchored to another UPF. This may cause QoS flow 108-1 for the PDU session to be discontinued and a different QoS flow 108-2 to be established between UE 102, now in area 106-2, and core network 206. Although UE 102 may be assigned a new IP address when it moves to area 106-2, components of the system for providing QoS continuity within environment 100 ensure that QoS flow 108-2 is established or created with the same QoS Identifier (e.g., a 5G QoS Identifier (5QI) or a QoS Class Identifier (QCI)) as QoS flow 108-1, thus maintaining QoS flow continuity.

To ensure that QoS flow 108-2 has the same 5QI or QCI as QoS flow 108-1, AF 314 may initiate a QoS flow continuity setup, by issuing a traffic influence API call (e.g., a new, improved traffic influence API call) to NEF 312. The call may specify that NEF 312 is to ensure the QoS flow continuity when UE 102 relocates or re-anchors. Upon receipt of the call, NEF 312 may store QoS information and traffic steering rules in core network 206, completing the setup.

Next, when UE 102 initiates a PDU session, AF 314 may issue a request to NEF 312 to establish a QoS flow 108-1 that has a particular 5QI or QCI. When NEF 312 receives the request from AF 314, NEF 312 may subscribe to a path change notification service and issue a request for a creation of policy authorization to core network 206. As a consequence of NEF 312's actions, core network 206 may establish, between UE 102 and a UPF, a PDU session that includes a desired QoS flow 108-1. Once the PDU session is established, NEF 312 may record information pertaining to the QoS flow 108-1 in a traffic influence table.

Later, when UE 102 moves to area 106-2, NEF 312 may receive a notification from core network 206 that UE 102 is to change its traffic path. In response, NEF 312 may check its database to determine whether UE 102 is to receive QoS flow continuity service. If so, NEF 312 may request core network 206 to authorize the creation of a new QoS flow. In response, core network 204 may re-anchor the PDU session, which may result in the creation of a new QoS flow 108-2 with the same 5QI as the prior QoS flow 108-1. Once the PDU session is re-anchored, NEF 312 may update QoS flow information in the traffic influence table.

In the above, when UE 102 moves from area 106-1 to area 106-2, the system provides QoS flow continuity. In particular, when the PDU session between UE 102 and core network 204 is re-anchored, QoS flow 108-1, which is no longer used, is replaced with QoS flow 108-2 that includes the same 5QI or QCI as QoS flow 108-1.

Although FIG. 1 shows the system as including 5G core network components (e.g., AF 314 and NEF 312), in other implementations, the system may include other types of core network components. For example, in a 4G network, the system may include a Service Capability Exposure Function (SCEF) in place of NEF 312, an application server in place of AF 314, and a PGW in place of a UPF.

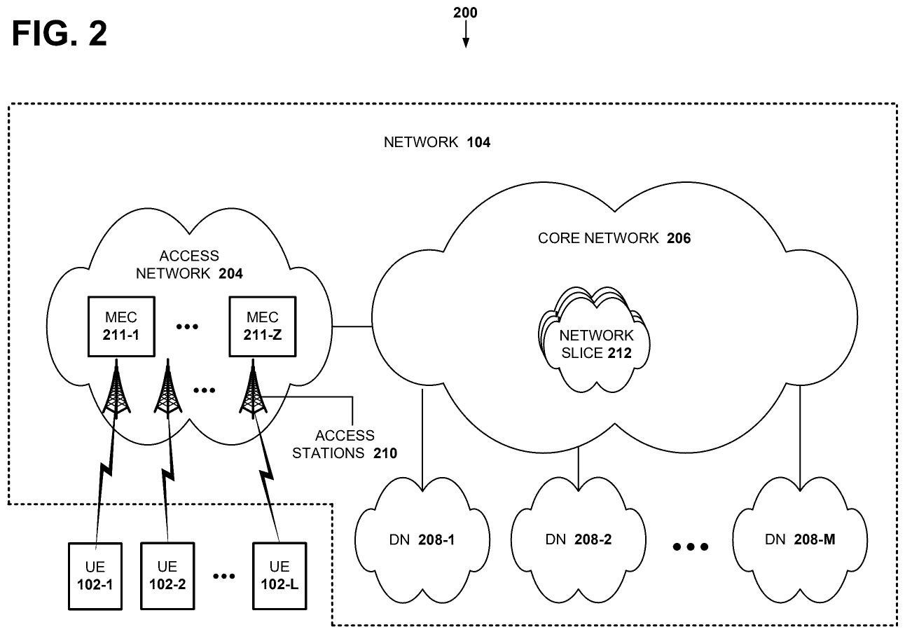

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNs) 208-1 through 208-M (collectively referred to as data networks 208 and generically as data network 208). Access network 204, core network 206, and data networks 208 may be part of provider network 104.

UEs 102 may include a wireless communication device capable of Fourth Generation (4G) (e.g., Long-Term Evolution (LTE)) communication, Fifth Generation (5G) New Radio (NR) communication, and/or other wireless communication. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor; an Internet-of-Things (IoT) device; a Fixed Wireless Access (FWA) device; and a Customer Premises Equipment (CPE) device with 4G and 5G capabilities. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 102 may be associated with a user that is subscribed to network 104 to receive various services. As indicated above, UE 102 may place its service flows in a QoS flow and package its QoS flows as part of a PDU session whose endpoints include UE 102 and a node in core network 206. The service flow may extend from UE 102 to a point beyond the node in core network 206, such as an application hosted on DN 208, a MEC cluster 211, or a network slice 212. After UE 102 opens a PDU session (which contains a particular QoS flow) and moves to a different location, the PDU session may be anchored to a different endpoint (e.g., a different UPF in a 5G network or a different PGW in a 4G network).

Access network 204 may facilitate UE 102's connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

As further shown, access network 204 may include one or more MEC clusters 211-1 through 211-Z (collectively referred to as MEC clusters 211 and generically referred to as MEC cluster 211). Each MEC cluster 211 may include MEC devices arranged to provide failover mechanisms. Each MEC device may be coupled to an access station 210 (or other RAN devices such as CU, DU, etc.). Because of its proximity to access station 210 and therefore its proximity to UEs 102 attached to access station 210 via wireless communication links, the MEC devices may provide services to UEs 102 with minimal latency.

When UE 102 moves from one location to another, UE 102 that is anchored to a UPF, which acts as a gateway on MEC cluster 211, may become re-anchored to another UPF that acts as a gateway to another MEC cluster 211. This may result in establishing a new QoS flow (over a PDU session between UE 102 and the other UPF) with a different QoS than the prior QoS for the initial QoS flow. Environment 100 permits the QoS (e.g., the same 5QI or QCI) to be maintained for the new QoS flow.

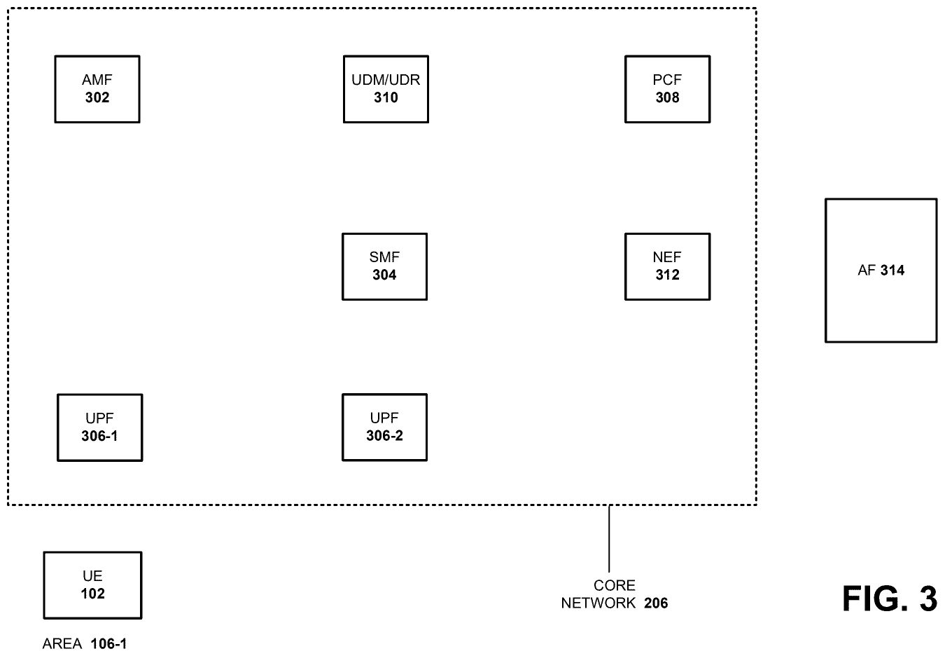

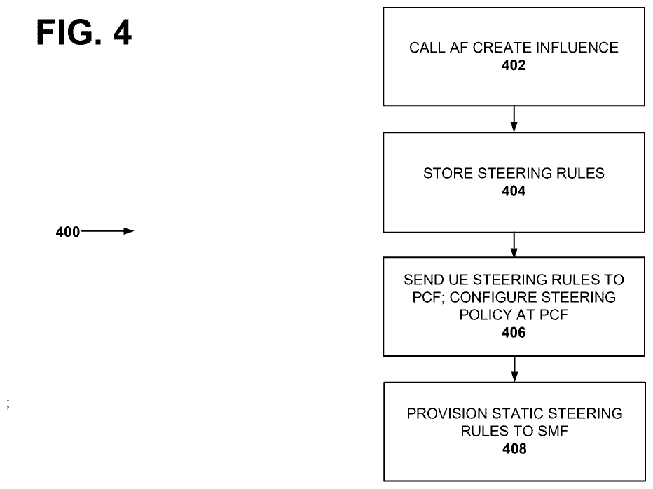

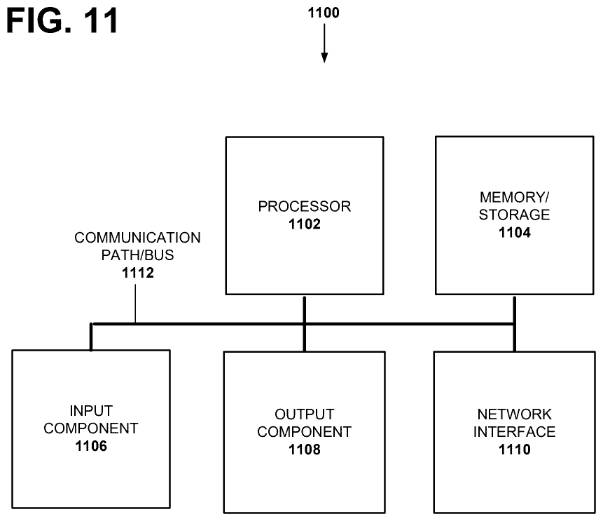

Core network 206 may oversee communication sessions for subscribers connecting via access network 204. For instance, core network 206 may facilitate the establishment of IP connections between UEs 102 and data networks 208. The components within core network 206 can be either dedicated hardware elements or virtualized functions operating atop a shared physical infrastructure using software defined networking (SDN). An SDN controller, for example, may leverage an adapter to implement one or more core network components through virtualized entities like virtual network functions (VNF) virtual machines, cloud native function (CNF) containers, event-driven serverless architecture interfaces, or other SDN components. This shared physical infrastructure may include devices 1100, as described below with reference to FIG. 11, within a cloud computing center associated with core network 206. Moreover, core network 206 may encompass 5G core network components, 4G core network components, or other types of core components. General descriptions of some of these components are provided below with reference to FIG. 3. Some of these components implement part of systems and methods for providing QoS flow continuity. Operations of these components for supporting QoS flow continuity are described below in greater detail with reference to FIGS. 4-10.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, central processing unit (CPU) cycles, memory, etc. Furthermore, each network slice 212 may be configured to meet a different set of requirements and may be associated with a particular QoS Class Identifier, a type of service, a 5G QoS Identifier, and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an access point name (APN) in 4G. UE 102 may request a connection to data network 208 using a DNN or APN. In a 5G network, data network 208 that is implemented on network slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302-314 in core network 206 according to an implementation. One or more of 5G core network components 302-314 in combination with other network components, may implement the systems and methods for providing QoS flow continuity. As shown, core network 206 may include at least an Access and Mobility Management Function (AMF) 302, a Session Management Function (SMF) 304, UPFs 306-1 and 306-2 (herein collectively referred to as UPFs 306 and generically as UPF 306), a Policy Control Function (PCF) 308, a Unified Data Management (UDM) and Unified Data Repository (UDR) 310, a Network Exposure Function (NEF) 312, and AF 314. Depending on the implementation, core network 206 may or may not include AF 314 (hence shown as outside core network. General descriptions of these components follow. Specific functions of these components within the systems for providing QoS flow continuity are described with reference to flow diagrams and messaging diagrams of FIGS. 4-7, 9, and 10.

AMF 302 may perform registration management, connection management, reachability management, mobility management, lawful intercepts, Short Message Service (SMS) transport between UE 102 and a Short Message Service Function (SMSF), session management messages transport between UE 102 and SMF 304, access authentication and authorization, location services management, functionality to support non-Third Generation Partnership Program (3GPP) access networks, and/or other types of management processes.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate charging data collection, terminate session management parts of Non-Access Stratum (NAS) messaging, perform downlink data notification, manage roaming functionality, and/or perform other types of control plane processes for managing user plane data.

UPF 306 may maintain an anchor point for intra/inter-Radio Access Technology (RAT) mobility, maintain an external PDU point of interconnect to a particular data network (e.g., data network 208), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., access station 210), and/or perform other types of user plane processes.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement.

UDM/UDR 310 may include one or more UDM and at least one UDR. The UDM may maintain subscription information for UEs 102, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. The UDM may store the data that it manages in the UDR. The UDR may include subscription data, policy data, and application data. The subscription data may include data associated with the subscribers of network services (e.g., users of UE 102), such as data pertaining to UE 102, services to which the user is subscribed, etc. The policy data may include policy rules and parameters associated with the policy rules. The application data may comprise information and/or data collected by applications.

NEF 312 may expose network services and capabilities to external applications or functions (e.g., external AF 314), such as third-party services, while ensuring security, authorization, and control. NEF 312 may allow external applications to interact with the 5G core components by providing APIs for services, such as session management, location information, and policy control.

AF 314 may be an external or internal application that interacts with the 5G core network components, to request specific services, such as managing QoS, accessing network capabilities, or sending/receiving data like SMS messages. AF 314 may operate in combination with NEF 312 to securely communicate with core network functions. AF 314 may request core network 206 to direct traffic to a particular device or network, such as particular UPF 306, MEC 211, and an endpoint in network slice 212.

Although core network 206 is depicted as including network components 302-314 in FIG. 3, in other implementations, core network 206 may include additional, fewer, and/or different 5G core network components than those illustrated in FIG. 3. For example, core network 206 may further include an Authentication Server Function (AUSF), a Charging Function (CHF), a Network Slice Selection Function (NSSF), a Network Repository Function (NRF), a Network Data Analytics Function (NWDAF), etc.

The systems and methods described herein may be implemented not only with 5G core network components, such as components 302-314, but with 4G core network components or a combination of 4G and 5G core network components. In such implementations, core network 206 may include a Mobility Management Function (MME), Serving Gateway (SGW), a Packet Data Network Gateway (PGW), a Policy and Charging Rules Function (PCRF), a Home Subscriber Server (HSS), a Service Capability Exposure Function, and an Application Server. These components may correspond to and play similar roles, respectively, as AMF 302, SMF 304, UPF 306, PCF 308, UDM/UDR 310, NEF 312, and AF 314 in a 5G core network.

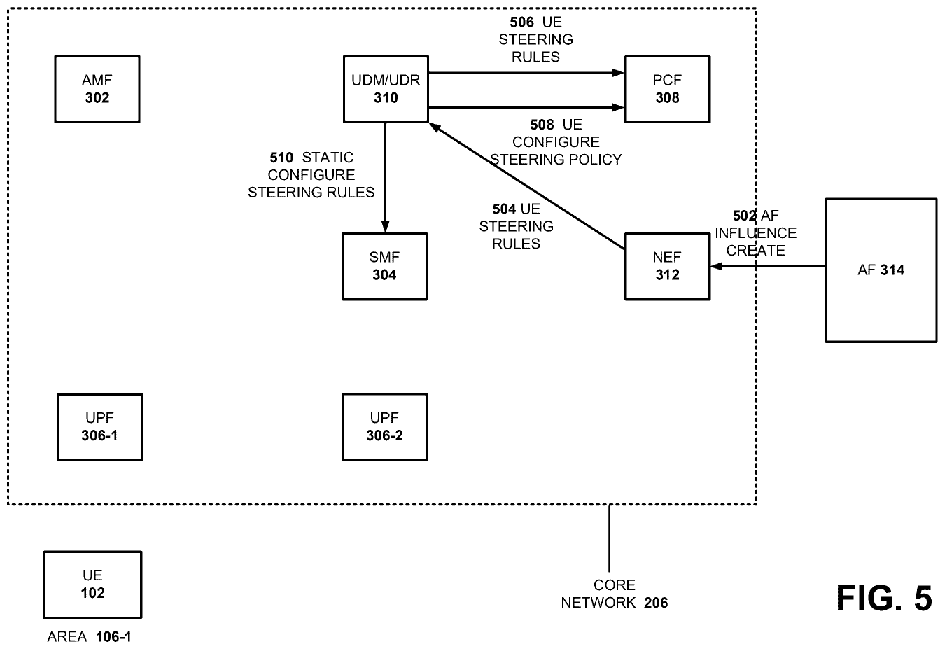

FIG. 4 is a flow diagram of an exemplary process 400 that is associated with an initial setup for providing QoS flow continuity. FIG. 5 shows a diagram illustrating example messages exchanged between network components during process 400. FIG. 5 is described below together with process 400. Process 400 may be performed by various components of network 104, including those depicted in FIGS. 1-3. Each block and/or arrow in FIGS. 4 and 5 is not intended to signify every action performed by the network components or every message sent by the components. For example, FIGS. 4 and 5 may not show some actions and/or messages transmitted as notifications in response to subscriptions or as responses to messages. Assume that AF 314 has determined to provide QoS flow continuity via core network 206.

As shown in FIG. 4, process 400 may include AF 314 calling NEF 312 to create a traffic influence or an AF influence (block 402; arrow 502). The call may include parameters (or arguments), such as, for example, Generic Public Subscription Identifier (GPSI), a DNN, a S-NSSAI, a traffic influence area (e.g., a cell ID, Tracking Area Identifier (TAI), etc.), a User Plane (UP) Path selection policy, traffic route/redirection information, a duration, a priority associated with the influence request, and monitoring parameters (e.g., threshold associated with measuring latency, jitter, etc.). In response to the call, NEF 312 may update or create the corresponding UE steering rules and store the rule at UDM/UDR 310 (block 404; arrow 504).

At block 406, when UDM/UDR 310 receives and stores the UE steering rules from NEF 312, UDM/UDR 310 may send the UE steering rules to PCF 308 (block 406; arrow 506) and configure UE steering policy at PCF 308 (block 406; arrow 508). That is, UDM/UDR 310 may send or set policy configuration parameters, such as priority levels and QoS parameters at PCF 308. Next, UDM/UDR 310 may provision static UE steering rules (e.g., a predefined policy rule that does not frequently change based on real-time network conditions) to SMF 304 (block 408; arrow 510). Such a rule may specify, for example, the route that user traffic should take through the network, the network slice or the DNN to which the traffic should be directed, and QoS parameters.

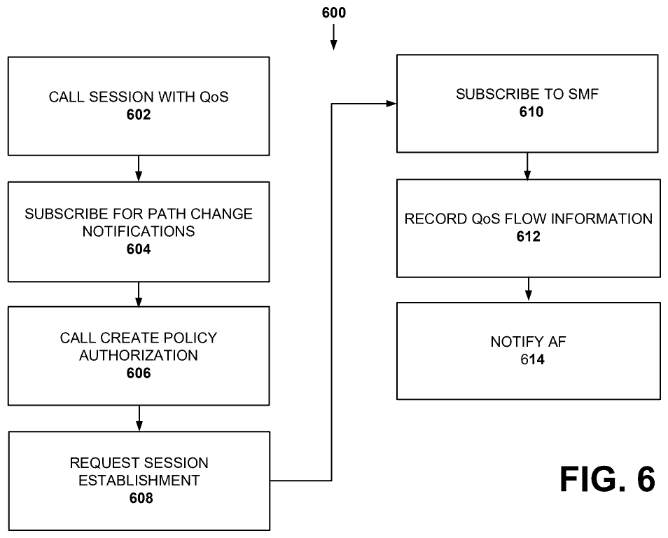

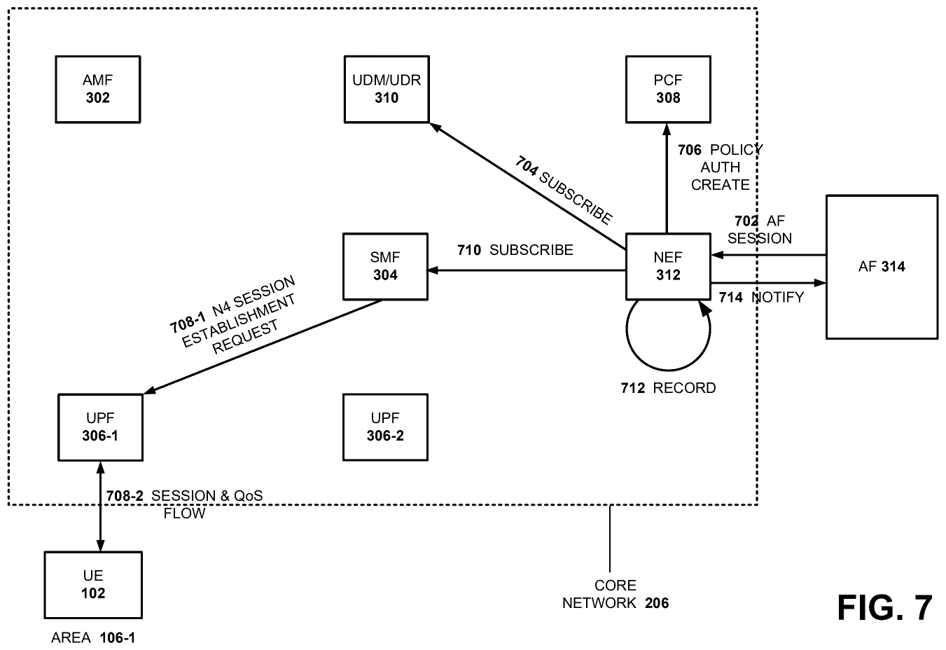

FIG. 6 is a flow diagram of an exemplary process 600 that is associated with establishing a new QoS flow by a system for providing QoS flow continuity. FIG. 7 shows a diagram illustrating example messages exchanged between different components of the system during process 600. FIG. 7 is described below together with process 600 of FIG. 6. Process 600 may be performed by various components of network 104, including those depicted in FIGS. 1-3 and 5. Each block and/or arrow in FIGS. 6 and 7 is not intended to signify every action performed by the network components or every message sent by the components.

For the following description, assume that the components shown in FIG. 7 have performed process 400, that UE 102 has sent a request to create a PDU session to AMF 302, and that SMF 304 is about to receive a call from AMF 302 to establish a session or that SMF 304 has already received such a call from AMF 302.

As shown, process 600 may include AF 314 making a call for a session with QoS (block 602; arrow 702). The call, when made, requests core network 206 to meet QoS requirements specified in the call. For example, AF 314 may call AF Session with QoS. The arguments of the call may include, for example, an AF ID, a UE ID (e.g., a UE IP address or a Media Access Control (MAC) address, etc.), a QoS flow description (e.g., desired latency, throughput, etc.) and an auto-relocation flag, which indicates whether NEF 312 is to provide QoS flow continuity automatically. In response to the call, NEF 312 may subscribe with UDM/UDR 310, to be notified of impending UE path changes. The subscription request may include the UE ID, as well as a specification of events to which NEF 312 wants notification (e.g., path changes to UE 102) (block 604; arrow 704). Furthermore, NEF 312 may call PCF 308 to create policy authorization for UE 102, along with the UE ID and a QoS flow description (block 606; arrow 706). When PCF 308 receives a call from SMF 304 to create a policy association for a PDU session, PCF 308 may do so in light of the authorization created in response to the call from NEF 312.

Process 600 may further include SMF 304 requesting UPF 306 to establish a session (block 608; arrow 708-1). As noted above, it is assumed that SMF 304 has received a request (from AMF 302) to establish a session. In response, SMF 304 may first request PCF 308 to associate a policy with the session. Next, SMF 304 may request UPF 306-1 to establish the session. The request to UPF 306-1 may specify QoS flow requirements (e.g., 5QI, latency, jitter, etc.). In response, UPF 306-1 may establish a PDU session and a QoS flow (over the PDU session) with UE 102 (arrow 708-2).

Process 600 may further include NEF 312 subscribing to SMF 304 for notifications upon detecting UE path changes (block 610; arrow 710). In some implementations, this action may be performed by NEF 312 later but not after SMF 304 issues a request to modify a PDU session to a UPF. When SMF 304 provides a notification regarding the established session and the QoS flow, NEF 312 may record the QoS flow information in its traffic influence table (block 612; arrow 712). NEF 312 may later use the recorded information to provide QoS flow continuity if UE 102 changes its location and UE 102 needs to be re-anchored to a different UPF. After recording the flow information, NEF 312 may then notify AF 314 that the session has the required QoS by AF 314 (block 614; arrow 714).

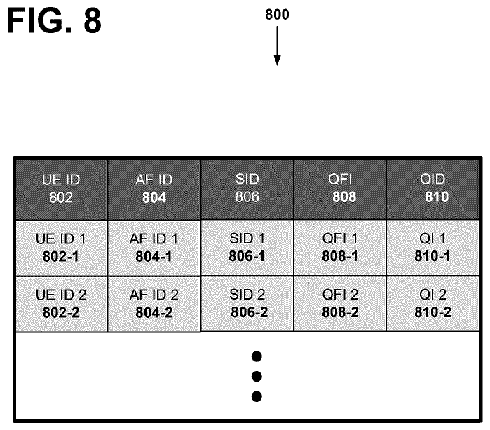

FIG. 8 shows example traffic influence table 800 that may be maintained by NEF 312 for storing QoS flow information. As shown, traffic influence table 800 may include multiple records, each of which includes a UE ID field 802, an AF ID field 804, a session ID field (SID) 806, a QoS flow ID (QFI) field 808, and a QoS ID (QID) field 810. Depending on the implementation, records in table 800 may include additional, fewer, different, or a different arrangement of fields than those illustrated in FIG. 8.

UE ID field 802 may store information that identifies UE 102, which is about to or has received QoS flow continuity service. AF ID field 804 may identify AF 314 which requested NEF 312 to influence UE 102 traffic path and/or to provide QoS flow continuity. Session ID field 806 may include information that identifies the PDU session which includes the QoS flow (which meets AF 314's requested QoS requirements) for UE 102. QFI field 808 may store information that identifies the QoS flow for UE 102. QID field 810 may store a QoS identifier, such as 5QI or QCI.

Referring back to FIGS. 6 and 7, After recording the QoS flow information in traffic influence table 800, NEF 312 may notify AF 314 that a session has been created with the QoS flow requirements specified by AF 314 (block 614; arrow 714). The notification may include a session ID and an indication whether the QoS flow requirement (see block 602) has been successfully met.

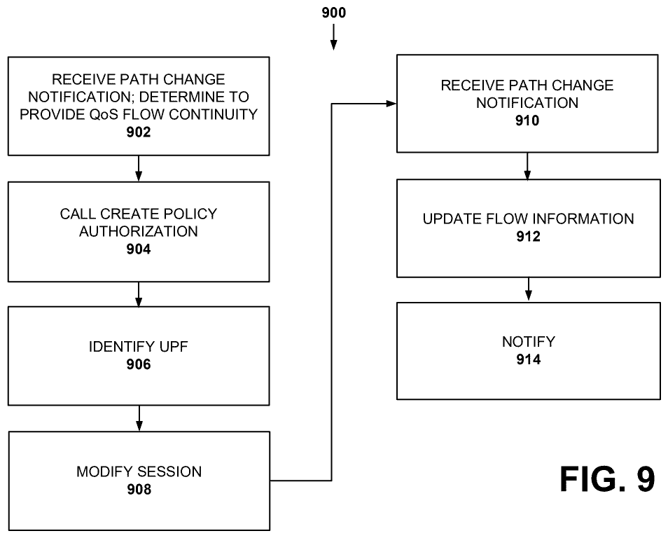

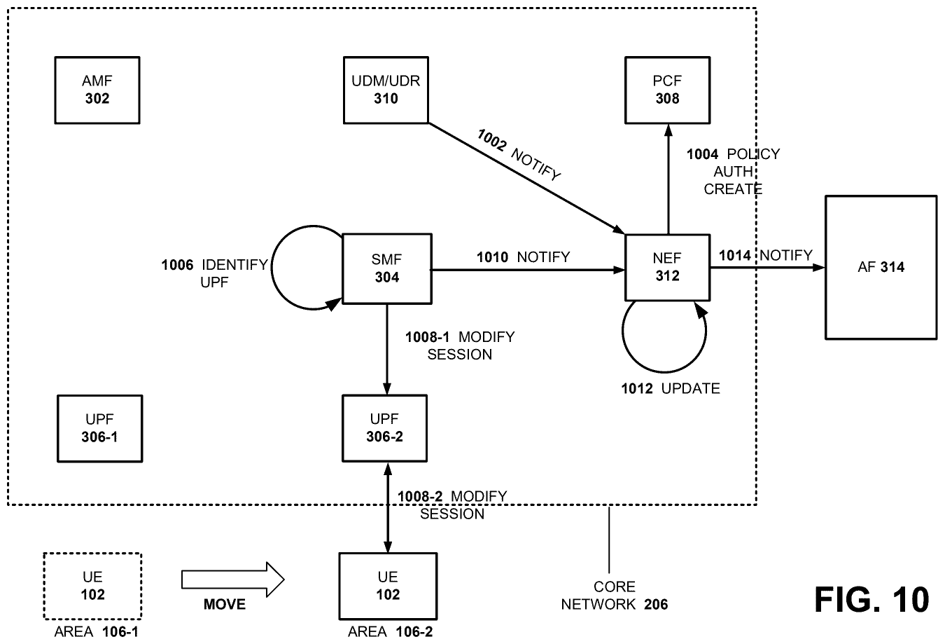

FIG. 9 is a flow diagram of an exemplary process 900 that is associated with reestablishing a QoS flow by the system for providing QoS flow continuity. FIG. 10 shows a diagram illustrating example messages exchanged between different components of the system during process 900. FIG. 10 is described below together with process 900 of FIG. 9. Process 900 may be performed by various components of network 104, including those depicted in FIGS. 1-3, 5, 8, and 10. Each block and/or arrow in FIGS. 9 and 10 is not intended to signify every action performed by the network components or every message sent by the components.

For the following, assume that the components shown in FIG. 10 have performed process 600. In addition, assume that UE 102 has moved from area 106-1 to area 106-2, triggering a handover and the re-anchoring process. Furthermore, assume that after the UE 102's establishment of a Radio Resource Control (RRC) with an access station 210 (not shown in FIG. 10) in area 106-2, AMF 302 has sent a request to modify a PDU session to SMF 304 and that SMF 304 has sent a message to UDM/UDR 310 about UE 102's path change.

As shown, process 900 may include NEF 312 receiving a path change notification from UDM/UDR 310. As shown in FIG. 7, NEF 312 is subscribed to UDM/UDR 310 for path change notification. Hence, when UDM/UDR 310 detects an impending path change (due to the message from SMF 304), UDM/UDR 310 may notify NEF 312 (block 1002; arrow 1002). When NEF 312 receives the notification from UDM/UDR 310 that a path change is to occur for UE 102, NEF 312 may determine whether there is an entry for UE 102 in its traffic influence table 800. If there is an entry for UE 102, NEF 312 may determine that UE 102 is to be provided with QoS flow continuity service. Next, NEF 312 may call PCF 308 to create policy authorization (block 904; arrow 1004), specifying QID indicated for UE 102 in the traffic influence table 800. Consequently, when SMF 304 sends a request to PCF 308 to associate a policy with a modified PDU session, PCF 308 may do so since the association is authorized.

Process 900 may further include SMF 304 identifying a UPF as the endpoint for re-anchoring UE 102 (block 906; arrow 1006). For example, SMF 304 may identify UPF 306-2 as the UPF for the re-anchoring endpoint. The identification process may depend on, for example, to which access station 210 (not shown in FIG. 10) UE 102 is attached after moving to area 106-2. For example, UPF 306-2 may be identified as the UPF in MEC cluster 211 to which access station 210 is coupled to minimize latency.

After selecting UPF 306-2, SMF 304 may request UPF 306-2 to modify the PDU session (formerly between UPF 306-1 and UE 102) so that UPF 306-2 serves as an anchor for the modified PDU session (block 908; arrow 1008-1). Upon receipt of the modify PDU session request from SMF 304, UPF 306-2 may establish the modified PDU session between UE 102 and UPF 306-2, where the modified PDU session carries/includes the QoS flow (arrow 1008-2). To maintain the QoS continuity, the QoS flow may have the same QI as the prior QoS flow.

Once the PDU session is modified with a QoS with the same QI as the prior QoS flow, SMF 304 may notify NEF 312 of the completed path change (block 910; arrow 1010). In response, NEF 312 may update the QoS flow information in its traffic information table 800 (block 912; arrow 1012). For example, NEF 312 may update session ID field 806 and/or QFI field 808 for the record associated with UE 102 and AF 314. Once the update is complete, NEF 312 may notify AF 314 of the change to the QoS flow (block 914; arrow 1014).

FIG. 11 depicts exemplary components of a network device 1100. Network device 1100 may correspond to or be included in any of the devices and/or components illustrated in FIGS. 1-10 (e.g., network 104, UE 102, access network 204, core network 206, data network 208, access station 210, and core network components 302-314). In some implementations, network devices 1100 may be part of a hardware network layer on top of which other network layers and network functions may be implemented.

As shown, network device 1100 may include a processor 1102, memory/storage 1104, input component 1106, output component 1108, network interface 1110, and communication path 1112. In different implementations, network device 1100 may include additional, fewer, different, or different arrangement of components than the ones illustrated in FIG. 11. For example, network device 1100 may include line cards, switch fabrics, modems, etc.

Processor 1102 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1100 and/or executing programs/instructions.

Memory/storage 1104 may include static memory, such as read only memory (ROM), and/or dynamic memory, such as random access memory (RAM), or onboard cache, for storing data and machine-readable instructions (e.g., programs, scripts, etc.). Memory/storage 1104 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1104 may be external to and/or removable from network device 1100.

Memory/storage 1104 may include, for example, a Universal Serial Bus (USB) memory stick, a dongle, a hard disk, off-line storage, a Blu-Ray® disk (BD), etc. Memory/storage 1104 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1106 and output component 1108 may provide input and output from/to a user to/from network device 1100. Input/output components 1106 and 1108 may include a display screen, a keyboard, a mouse, a speaker, a microphone, a camera, a DVD reader, USB lines, and/or other types of components for obtaining, from physical events or phenomena, to and/or from signals that pertain to network device 1100.

Network interface 1110 may include a transceiver (e.g., a transmitter and a receiver) for network device 1110 to communicate with other devices and/or systems. For example, via network interface 1110, network device 1100 may communicate over a network, such as the Internet, an intranet, cellular, a terrestrial wireless network (e.g., a wireless LAN, WIFI, WIMAX, etc.), a satellite-based network, optical network, etc. Network interface 1110 may include a modem, an Ethernet interface to a LAN, and/or an interface/connection for connecting network device 1100 to other devices (e.g., a Bluetooth interface).

Communication path or bus 1112 may provide an interface through which components of network device 1100 can communicate with one another.

Network device 1100 may perform the operations described herein in response to processor 1102 executing software instructions stored in a non-transient computer-readable medium, such as memory/storage 1104. The software instructions may be read into memory/storage 1104 from another computer-readable medium or from another device via network interface 1110. The software instructions stored in memory/storage 1104, when executed by processor 1102, may cause processor 1102 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4-7, 9, and 10. the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term PDU session (a protocol data unit session) or PDN session (a packet data network session) may refer to communication between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDN session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising a processor configured to:
receive, from a core network, a first notification of a path change to a network traffic associated with a User Equipment (UE) device;
determine whether the UE is to receive a Quality-of-Service (QoS) flow continuity service by looking up traffic influence information for the UE in a table; and
when it is determined that the UE is to receive the QoS flow continuity service, send a message to the core network to provide QoS flow continuity service,
wherein the QoS flow continuity service sets a QoS, of a first QoS flow for the UE after the path change, to a QoS of a second QoS flow for the UE prior the path change.

2. The device of claim 1, wherein the device includes a Network Exposure Function (NEF), and wherein, when the processor receives the first notification, the processor is further configured to:
receive, from a Unified Data Management (UDM) or a Unified Data Repository (UDR), a second notification of the path change.

3. The device of claim 1, wherein, when the processor sends the message to the core network, the processor is configured to:
send a request to a Policy Control Function (PCF) to create an authorization for a policy pertaining to the path change to direct the network traffic from the UE to a new User Plane Function (UPF).

4. The device of claim 1, wherein the table includes at least one of:
an identifier for the UE;
an identifier for the second QoS flow; or
an identifier for a QoS for the second QoS flow.

5. The device of claim 1, wherein, prior to receipt of the first notification, the processor is further configured to:
receive a request from an Application Function (AF) for the core network to create a session having a QoS flow that meets one or more QoS requirements;
subscribe with a Unified Data Management (UDM) or a Unified Data Repository (UDR) to receive a path change notification; and
request a Policy Control Function (PCF) to create an authorization for a policy to be associated with a creation of QoS flow, for the UE, that meets the QoS requirements.

6. The device of claim 5, wherein the processor is further configured to:
subscribe with a Session Management Function (SMF) to be notified of an establishment of a session that includes the first QoS flow;
receive a second notification from the SMF that the session is established; and
store parameters associated with the first QoS flow in the table.

7. The device of claim 6, wherein the processor is further configured to:
notify the AF of a successful creation of the first QoS flow.

8. The device of claim 1, wherein the processor is further configured to:
receive, from an Application Function (AF), a request to create a traffic influence; and
store traffic steering rules, at a Unified Data Repository (UDR), in response to the request to create the traffic influence.

9. The device of claim 8, wherein the UDR is configured to:
provide the traffic steering rules to a Policy Control Function (PCF); and
provide static traffic steering rules to a Session Management Function (SMF).

10. The device of claim 1, wherein the processor is further configured to:
send an update notification to provide updated session information associated with the path change.

11. A method comprising:
receiving, from a core network, a first notification of a path change to a network traffic associated with a User Equipment (UE) device;
determining whether the UE is to receive a Quality-of-Service (QoS) flow continuity service by looking up traffic influence information for the UE in a table;
when it is determined that the UE is to receive the QoS flow continuity service, sending a message to the core network to provide QoS flow continuity service,
wherein the QoS flow continuity service sets a QoS, of a first QoS flow for the UE after the path change, to a QoS of a second QoS flow for the UE prior the path change.

12. The method of claim 11, wherein receiving the first notification includes:
receiving, from a Unified Data Management (UDM) or a Unified Data Repository (UDR), a second notification of the path change.

13. The method of claim 11, wherein sending the message to the core network includes:
sending a request to a Policy Control Function (PCF) to create an authorization for a policy pertaining to the path change to direct the network traffic from the UE to a new User Plane Function (UPF).

14. The method of claim 11, wherein the table includes at least one of:
an identifier for the UE;
an identifier for the second QoS flow; or
an identifier for a QoS for the second QoS flow.

15. The method of claim 11, further comprising, prior to receiving the first notification:
receiving a request from an Application Function (AF) for the core network to create a session having a QoS flow that meets one or more QoS requirements;
subscribing with a Unified Data Management (UDM) or a Unified Data Repository (UDR) to receive a path change notification; and
requesting a Policy Control Function (PCF) to create an authorization for a policy to be associated with a creation of QoS flow, for the UE, that meets the QoS requirements.

16. The method of claim 15, further comprising:
subscribing with a Session Management Function (SMF) to be notified of an establishment of a session that includes the first QoS flow;
receiving a second notification from the SMF that the session is established; and
storing parameters associated with the first QoS flow in the table.

17. The method of claim 16, further comprising:
notifying the AF of a successful creation of the first QoS flow.

18. The method of claim 11, further comprising:
receiving, from an Application Function (AF), a request to create a traffic influence; and
storing traffic steering rules, at a Unified Data Repository (UDR), in response to the request to create the traffic influence.

19. The method of claim 18, wherein the UDR is configured to:
provide the traffic steering rules to a Policy Control Function (PCF); and
provide static traffic steering rules to a Session Management Function (SMF).

20. A non-transitory computer-readable medium comprising processor-executable
instructions, which when executed by a processor, cause the processor to:
receive, from a core network, a first notification of a path change to a network traffic associated with a User Equipment (UE) device;
determine whether the UE is to receive a Quality-of-Service (QoS) flow continuity service by looking up traffic influence information for the UE in a table; and
when it is determined that the UE is to receive the QoS flow continuity service, send a message to the core network to provide QoS flow continuity service,
wherein the QoS flow continuity service sets a QoS, of a first QoS flow for the UE after the path change, to a QoS of a second QoS flow for the UE prior the path change.
